(19) United States
(12) Patent Application Publication
(10) Pub. No.: US 2025/0266918 A1
(43) Pub. Date: Aug. 21, 2025

(54) ENHANCED PATHLOSS REFERENCE SIGNAL MEASUREMENT

(71) Applicant: Nokia Technologies Oy, Espoo (FI)

(72) Inventors: Parham KAZEMI, Espoo (FI); Lei DU, Beijing (CN); Lars DALSGAARD, Oulu (FI); Bent Henneberg RYSGAARD, Aalborg (DK); Karri Markus RANTA-AHO, Espoo (FI)

(21) Appl. No.: 19/046,324

(22) Filed: Feb. 5, 2025

(30) Foreign Application Priority Data
Feb. 15, 2024 (WO) PCT/CN2024/077232

(51) Int. Cl. H04B 17/309; H04B 7/06; H04B 17/318; H04L 5/00; H04W 24/10; H04W 52/14; H04W 56/00

(52) U.S. Cl. CPC H04B 17/347; H04B 7/0626; H04B 17/328; H04L 5/0048; H04L 5/0091; H04W 24/10; H04W 52/146; H04W 56/001

(57) ABSTRACT

Embodiments of the present disclosure relate to enhanced pathloss reference signal (PL-RS) measurement. In an aspect, a terminal device receives, from a network device via a first cell, an activation command for activating at least one second cell. The terminal device receives, from the network device via the at least one second cell, at least one synchronized signal block (SSB) associated with the activation of the at least one second cell. The terminal device performs time and frequency synchronization based on the at least one SSB, and determines a first PL-RS based on the at least one SSB during the time and frequency synchronization. By implementing the embodiments of the present disclosure, the first PL-RS could be determined in parallel with/during the time and frequency synchronization process and the terminal device is able to perform the PL-RS measurement before receiving the TCI activation command, thereby reducing SCell activation delay.

### CROSS-REFERENCE TO RELATED APPLICATION

This application claims priority from, and the benefit of, PCT Application No. PCT/CN2024/077232, filed on Feb. 15, 2024, the contents of which is hereby incorporated by reference in their entirety.

### FIELD

Various example embodiments generally relate to the field of communication, and in particular, to a terminal device, a network device, methods, apparatuses and a computer readable storage medium related to enhanced pathloss reference signal (PL-RS) measurement.

### BACKGROUND

In communication technology, there is a constant evolution ongoing in order to provide efficient and reliable solutions for utilizing wireless communication networks. Each new generation has its own technical challenges for handling different situations and processes that are needed to connect and serve devices connected to wireless networks. To meet the demand for increased wireless data traffic since the deployment of 4th generation (4G) communication systems, efforts have been made to develop an improved 5th generation (5G), pre-5G, 5G-advanced, 6G, or beyond 6G communication system. The new communication systems can support various types of service applications for terminal devices.

In a communication technology, the third generation partnership project (3GPP) specified physical uplink control channel (PUCCH) SCell activation delay requirements, and using a PL-RS of the PUCCH SCell to determine an uplink transmitting power for transmitting channel state information (CSI) report for the PUCCH SCell activation. However, there are still some open problems related to PL-RS measurement that need to be studied.

### SUMMARY

In general, example embodiments of the present disclosure provide a terminal device, a network device, methods, apparatuses and a computer readable storage medium for communication, for example, for enhanced pathloss reference signal (PL-RS) measurement, especially for enhanced pathloss reference signal (PL-RS) measurement for reducing SCell activation delay.

In a first aspect, there is provided a terminal device. The terminal device may comprise at least one processor; and at least one memory storing instructions that, when executed by the at least one processor, cause the terminal device at least to: receive, from a network device via a first cell, an activation command for activating at least one second cell; receive, from the network device via the at least one second cell, at least one synchronized signal block (SSB) associated with the activation of the at least one second cell; perform time and frequency synchronization based on the at least one SSB; and determine a first pathloss reference signal (PL-RS) based on the at least one SSB during the time and frequency synchronization.

In a second aspect, there is provided a network device. The network device may comprise at least one processor; and at least one memory storing instructions that, when executed by the at least one processor, cause the network device at least to: transmit, to a terminal device via a first cell, an activation command for activating at least one second cell; transmit, to the terminal device via the at least one second cell, at least one synchronized signal block (SSB) associated with the activation of the at least one second cell; and receive, from the terminal device, a first indication of a first pathloss reference signal (PL-RS), which is determined based on the at least one SSB during time and frequency synchronization based on the at least one SSB.

In a third aspect, there is provided a method. The method may comprise: receiving, from a network device via a first cell, an activation command for activating at least one second cell; receiving, from the network device via the at least one second cell, at least one synchronized signal block (SSB) associated with the activation of the at least one second cell; performing time and frequency synchronization based on the at least one SSB; and determining a first pathloss reference signal (PL-RS) based on the at least one SSB during the time and frequency synchronization.

In a fourth aspect, there is provided a method. The method may comprise: transmitting, to a terminal device via a first cell, an activation command for activating at least one second cell; transmitting, to the terminal device via the at least one second cell, at least one synchronized signal block (SSB) associated with the activation of the at least one second cell; and receiving, from the terminal device, a first indication of a first pathloss reference signal (PL-RS), which is determined based on the at least one SSB during time and frequency synchronization based on the at least one SSB.

In a fifth aspect, there is provided an apparatus. The apparatus may comprise: means for receiving, from a network device via a first cell, an activation command for activating at least one second cell; means for receiving, from the network device via the at least one second cell, at least one synchronized signal block (SSB) associated with the activation of the at least one second cell; means for performing time and frequency synchronization based on the at least one SSB; and means for determining a first pathloss reference signal (PL-RS) based on the at least one SSB during the time and frequency synchronization.

In a sixth aspect, there is provided an apparatus. The apparatus may comprise: means for transmitting, to a terminal device via a first cell, an activation command for activating at least one second cell; means for transmitting, to the terminal device via the at least one second cell, at least one synchronized signal block (SSB) associated with the activation of the at least one second cell; and means for receiving, from the terminal device, a first indication of a first pathloss reference signal (PL-RS), which is determined based on the at least one SSB during time and frequency synchronization based on the at least one SSB.

In a seventh aspect, there is provided a non-transitory computer readable medium comprising program instructions for causing an apparatus to perform at least the method according to the fifth to sixth aspects.

In an eighth aspect, there is provided a computer program comprising instructions, which, when executed by an apparatus, cause the apparatus at least to: receive, from a network device via a first cell, an activation command for activating at least one second cell; receive, from the network device via the at least one second cell, at least one synchronized signal block (SSB) associated with the activation of the at least one second cell; perform time and frequency synchronization based on the at least one SSB; and determine a first pathloss reference signal (PL-RS) based on the at least one SSB during the time and frequency synchronization.

In a ninth aspect, there is provided a computer program comprising instructions, which, when executed by an apparatus, cause the apparatus at least to: transmit, to a terminal device via a first cell, an activation command for activating at least one second cell; transmit, to the terminal device via the at least one second cell, at least one synchronized signal block (SSB) associated with the activation of the at least one second cell; and receive, from the terminal device, a first indication of a first pathloss reference signal (PL-RS), which is determined based on the at least one SSB during time and frequency synchronization based on the at least one SSB.

In a tenth aspect, there is provided a terminal device. The terminal device may comprise a first receiving circuitry configured to receive, from a network device via a first cell, an activation command for activating at least one second cell; a second receiving circuitry configured to receive, from the network device via the at least one second cell, at least one synchronized signal block (SSB) associated with the activation of the at least one second cell; a performing circuitry configured to perform time and frequency synchronization based on the at least one SSB; and a determining circuitry configured to determine a first pathloss reference signal (PL-RS) based on the at least one SSB during the time and frequency synchronization.

In an eleventh aspect, there is provided a network device. The network device may comprise a first transmitting circuitry configured to transmit, to a terminal device via a first cell, an activation command for activating at least one second cell; a second transmitting circuitry configured to transmit, to the terminal device via the at least one second cell, at least one synchronized signal block (SSB) associated with the activation of the at least one second cell; and a receiving circuitry configured to receive, from the terminal device, a first indication of a first pathloss reference signal (PL-RS), which is determined based on the at least one SSB during time and frequency synchronization based on the at least one SSB.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of an application scenario in which some example embodiments of the present disclosure may be implemented;

FIG. 2 illustrates an example signaling process of PL-RS determination in parallel with time and frequency synchronization in accordance with some example embodiments of the present disclosure;

FIG. 3A illustrates an example signaling process of PL-RS determination and PL-RS measurement in parallel with time and frequency synchronization in accordance with some example embodiments of the present disclosure;

FIG. 3B illustrates an example signaling process of PL-RS determination in parallel with time and frequency synchronization and PL-RS measurement after time and frequency synchronization in accordance with some example embodiments of the present disclosure;

FIG. 3C illustrates an example signaling process of PL-RS determination in parallel with time and frequency synchronization and PL-RS measurement after time and frequency synchronization in accordance with some other example embodiments of the present disclosure;

FIG. 4 illustrates a flowchart of an example method implemented at a terminal device in accordance with some embodiments of the present disclosure;

FIG. 5 illustrates a flowchart of an example method implemented at a network device in accordance with some embodiments of the present disclosure;

FIG. 6 illustrates an example simplified block diagram of a device that is suitable for implementing embodiments of the present disclosure; and

FIG. 7 illustrates an example block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first”, “second”, “third” and “fourth” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as new radio (NR), long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As discussed above, 3GPP specified PUCCH SCell activation delay requirements, and using PL-RS of the PUCCH SCell to determine an uplink transmitting power for transmitting CSI report for the PUCCH SCell activation. In the existing technologies, the PUCCH SCell activation delay is defined assuming that the PL-RS is indicated in or with an uplink spatial relation, which is included in a transmission configuration indicator (TCI) activation command. In this way, however, UE is not able to perform measurement on the associated PL-RS before receiving the TCI activation command, thus performing PL-RS measurement would add additional delay to the SCell activation delay. How to improve the PL-RS measurement to reduce the SCell activation delay needs to be studied.

Therefore, example embodiments of the present disclosure provide a solution for enhanced PL-RS measurement, especially for enhanced PL-RS measurement for reducing SCell activation delay by performing the PL-RS measurement before receiving the TCI activation command. According to embodiments of the present disclosure, a terminal device receives, from a network device via a first cell (e.g., primary cell, PCell), an activation command for activating at least one second cell (e.g., secondary cell, SCell). The terminal device receives, from the network device via the at least one second cell, at least one synchronized signal block (SSB) associated with the activation of the at least one second cell. Afterwards, the terminal device performs time and frequency synchronization based on the at least one SSB. During (in parallel with) the time and frequency synchronization, the terminal device determines a first pathloss reference signal (PL-RS) (e.g., default PL-RS) based on the at least one SSB.

It is understood that the above procedure steps may work together, in a flow of operations as described below, partly together or independently of each other. By implementing the embodiments of the present disclosure, the default PL-RS could be determined in parallel with/during the process of time and frequency synchronization and the terminal device is able to perform the PL-RS measurement before receiving the TCI activation command, thus the additional delay caused by the PL-RS measurement could be reduced, thereby reducing the SCell activation delay.

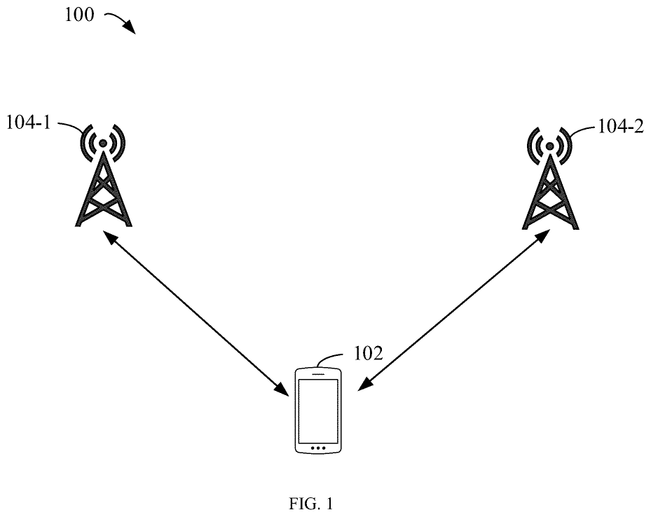

For illustrative purposes, principles and example embodiments of the present disclosure of elimination of activation signal interference in a network will be described below with reference to FIG. 1 through FIG. 7. However, it is to be noted that these embodiments are given to enable the skilled in the art to understand inventive concepts of the present disclosure and implement the solution as proposed herein, and not intended to limit scope of the present application in any way.

FIG. 1 illustrates an example of an application scenario 100 in which some example embodiments of the present disclosure may be implemented. The network environment 100, which may be a part of a communication network, includes a terminal device 102, a first network device 104-1, and a second network device 104-2.

As illustrated in FIG. 1, the terminal device 102 may also be referred to as a user equipment 102 or a UE 102. The first network device 104-1 may also be referred to as a gNB 104-1. The second network device 104-2 may also be referred to as a gNB 104-2. The terminal device 102 and the first network device 104-1 can communicate with each other. The terminal device 102 and the second network device 104-2 can also communicate with each other. The first network device 104-1 and the second network device 104-2 can also communicate with each other. Each of the first network device 104-1 and the second network device 104-2 could provide a PCell and at least one SCell for serving the terminal device 102. The terminal device 102 may be under a new radio-dual connectivity (NR-DC) or a multi-radio dual connectivity (MR-DC). The first network device 104-1 may be a master node (MN) while the second network device 104-2 may be a secondary node (SN). Alternatively, the first network device 104-1 may be an SN while the second network device 104-2 may be an MN.

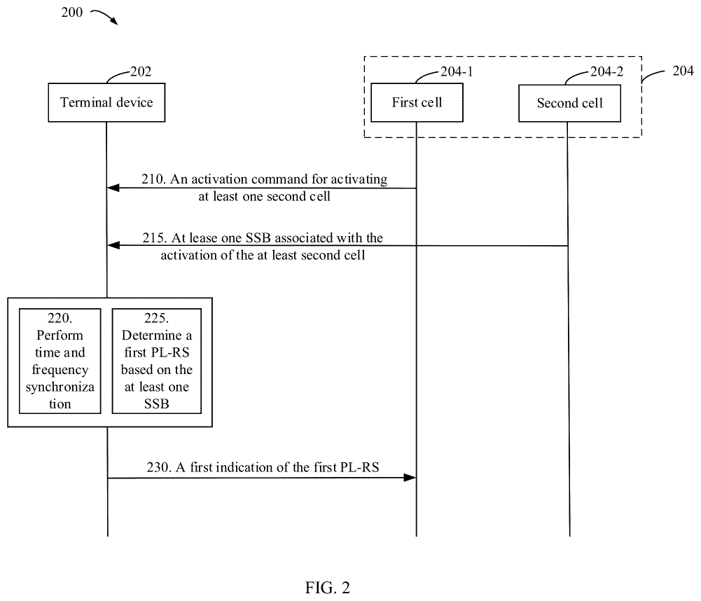

FIG. 2 illustrates an example signaling process 200 of PL-RS determination in parallel with time and frequency synchronization in accordance with some example embodiments of the present disclosure. For ease of understanding, the process 200 will be described with reference to FIG. 1.

As shown in FIG. 2, the process 200 may involve a terminal device 202 (e.g., a UE 202), a first cell 204-1 (e.g., a PCell 204-1) and a second cell 204-2 (e.g., an SCell 204-2). The terminal device 202 could be the terminal device 102 in FIG. 1, the first cell 204-1 could be a PCell served by the network device 104-1 in FIG. 1 and the second cell 204-2 could be at least one SCell served by the network device 104-2 in FIG. 1. Alternatively, the second cell 204-2 could be at least one SCell also served by the network device 104-1 in FIG. 1. The first cell 204-1 and the second cell 204-2 could be called as a network device 204 collectively.

At 210, the terminal device 202 receives from the network device 204 via a first cell 204-1, an activation command for activating at least one second cell 204-2. At the same time, in a reverse direction, the network device 204 transmits, to the terminal device 202 via the first cell 204-1, the activation command for activating the at least one second cell 204-2. At 215, the terminal device 202 receives, from the network device 204 via the at least one second cell 204-2, at least one synchronized signal block (SSB) associated with the activation of the at least one second cell 204-2. At the same time, in a reverse direction, the network device 204 transmits, to the terminal device 202 via the at least one second cell 204-2, the at least one SSB associated with the activation of the at least one second cell 204-2. Then, at 220, the terminal device 202 performs time and frequency synchronization based on the at least one SSB. At 225, the terminal device 202 determines a first pathloss reference signal (PL-RS) based on the at least one SSB during the time and frequency synchronization of 220. 220 and 225 are in parallel with each other. In this way, a first PL-RS (e.g., a default PL-RS) could be determined in parallel with/during the process of time and frequency synchronization and the terminal device 202 is able to perform the PL-RS measurement before receiving the TCI activation command, thus the additional delay caused by the PL-RS measurement could be reduced, thereby reducing the SCell activation delay.

In some example embodiments, the terminal device 202 may start to perform PL-RS measurement on the first PL-RS during the time and frequency synchronization. In some example embodiments, the terminal device 202 may complete the PL-RS measurement on the first PL-RS during the time and frequency synchronization. For example, if the time and frequency synchronization requires a number of SSBs (e.g., 8 SSBs), the terminal device 202 may be able to determine the default PL-RS and perform the PL-RS measurement within the time period for the time and frequency synchronization, thus the additional delay caused by the PL-RS measurement could be covered by the time period for the time and frequency synchronization. This may apply for a scenario in which the second cell 204-2 is unknown to the terminal device 202 and refined beam information associated with the second cell 204-2 is unknown to the terminal device 202.

In some example embodiments, the terminal device 202 may start to perform PL-RS measurement on the first PL-RS after the time and frequency synchronization. In some example embodiments, the terminal device 202 may start to perform the PL-RS measurement on the first PL-RS immediately after the time and frequency synchronization. Alternatively or additionally, the terminal device 202 may perform a layer 1 reference signal receiving power (L1-RSRP) measurement based on the at least one SSB after the time and frequency synchronization, and start to perform the PL-RS measurement on the first PL-RS after the L1-RSRP. This may apply for a scenario in which the second cell 204-2 is known to the terminal device 202 and refined beam information associated with the second cell 204-2 is known to the terminal device 202, thus the terminal device 202 could start to perform the PL-RS measurement for example using a narrow beam (i.e., narrow spatial setting) after the time and frequency synchronization. In this way, the delay for PL-RS determination could be covered by the time period for the time and frequency synchronization and the PL-RS measurement could be performed before the terminal device 202 receiving the TCI activation command.

At 230, the terminal device 202 may transmit, to the network device 204, a first indication of the first PL-RS. At the same time, in a reverse direction, the network device 204 may receive, from the terminal device 202, a first indication of the first PL-RS. In this way, the terminal device 202 could inform the network device 204 of the default PL-RS determined during the time period for the time and frequency synchronization, which could assist the network device 204 to use/activate the correct downlink beam using the TCI activation command. The first indication may be transmitted to the network device 204 via the first cell 204-1 or the second cell 204-2.

In some example embodiments, the terminal device 202 may transmit, to the network device 204, an L1-RSRP measurement report only containing an L1-RSRP measurement result corresponding to the first PL-RS. At the same time, in a reverse direction, the network device 204 may receive, from the terminal device 202, the L1-RSRP measurement report only containing the L1-RSRP measurement result corresponding to the first PL-RS. Alternatively or additionally, the terminal device 202 may transmit, to the network device 204, an L1-RSRP measurement report containing a PL-RS measurement result on the first PL-RS. At the same time, in a reverse direction, the network device 204 may receive, from the terminal device 202, the L1-RSRP measurement report containing the PL-RS measurement result on the first PL-RS. Alternatively or additionally, the terminal device 202 may transmit, to the network device 204, an L1-RSRP measurement report containing the first PL-RS. At the same time, in a reverse direction, the network device 204 may receive, from the terminal device 202, the L1-RSRP measurement report containing the first PL-RS. Alternatively or additionally, the terminal device 202 may transmit, to the network device 204, a layer 3 reference signal receiving power (L3-RSRP) measurement report containing the first PL-RS. At the same time, in a reverse direction, the network device 204 may receive, from the terminal device 202, the L3-RSRP measurement report containing the first PL-RS. Alternatively or additionally, the terminal device 202 may transmit, to the network device 204, a channel state information (CSI) report containing the first PL-RS. At the same time, in a reverse direction, the network device 204 may receive, from the terminal device 202, the CSI report containing the first PL-RS. Alternatively or additionally, the terminal device 202 may explicitly indicate the first PL-RS to the network device 204. In this way, the terminal device 202 could inform the network device 204 of the default PL-RS determined during the rime period of the time and frequency synchronization in a variety of specific means.

In some example embodiments, the terminal device 202 may receive, from the network device 204, a transmission configuration indicator (TCI) activation command containing a TCI state determined based on the first PL-RS. At the same time, in a reverse direction, the network device 204 may determine the TCI state based on the first PL-RS and transmit, to the terminal device 202, the TCI activation command containing the TCI state determined based on the first PL-RS. In this way, the network device 204 is able to align the TCI activation command with the default PL-RS determined by the terminal device 202 during the time period for the time and frequency synchronization.

In some example embodiments, the TCI activation command may further comprise a second PL-RS, and the terminal device 202 may determine whether to use the first PL-RS or the second PL-RS for determining a physical uplink control channel (PUCCH) transmission power for transmitting a CSI report for the at least one second cell 204-2. This applies for the scenario in which the network device 204 may further indicate (e.g., explicitly indicate in uplink spatial relation in the TCI activation command) the terminal device 202 of a second PL-RS different from the first PL-RS previously determined by the terminal device 202. In some example embodiments, based on determining to use the first PL-RS for determining the PUCCH transmission power, the terminal device 202 keeps using the PL-RS measurement on the first PL-RS. Alternatively or additionally, based on determining to use the second PL-RS for determining the PUCCH transmission power, the terminal device 202 performs PL-RS measurement on the second PL-RS. In this way, the terminal device 202 may still use the PL-RS measurement result on the first PL-RS, or additionally perform measurement on the second PL-RS further indicated.

In some example embodiments, the terminal device 202 may transmit, to the network device 204, a second indication indicating whether or not the terminal device 202 uses the first PL-RS for determining the PUCCH transmission power. At the same time, in a reverse direction, the network device 204 may receive, from the terminal device 202, the second indication indicating whether or not the terminal device 202 uses the first PL-RS for determining the PUCCH transmission power. In this way, the network device 204 would know the terminal device 202 uses which PL-RS for determining the PUCCH transmission power. In some example embodiments, if the first PL-RS is to be used for the determining the PUCCH transmission power for the PUCCH SCell activation, the first PL-RS may be considered as known to the terminal device 202 and the network device 204.

In some example embodiments, before receiving the activation command at 210, the terminal device 202 may transmit, to the network device 204, a third indication indicating the terminal device 202 is capable of using or prioritizing the first PL-RS for the activation of the at least one second cell 204-2. At the same time, in a reverse direction, the network device 204 may receive, from the terminal device 202, the third indication indicating the terminal device 202 is capable of using or prioritizing the first PL-RS for the activation of the at least one second cell 204-2. When the terminal device 202 is capable of using or prioritizing the first PL-RS (i.e., the default PL-RS), the terminal device 202 would be able to perform the following default PL-RS determination and measurement processes. Additionally, when the terminal device 202 is capable of prioritizing the first PL-RS, the terminal device 202 would preferably using the default PL-RS for determining the PUCCH transmission power when there also exists other PL-RS(s).

In some example embodiments, the terminal device 202 may transmit, to the network device 204, a fourth indication indicating the terminal device 202 is capable of using a small beam sweeping factor for faster time and frequency synchronization. At the same time, in a reverse direction, the network device 204 may receive, from the terminal device 202, the fourth indication indicating the terminal device 202 is capable of using a small beam sweeping factor for faster time and frequency synchronization. In this way, the time period for the time and frequency synchronization would be shorter.

In some example embodiments, the at least one second cell 204-2 may comprise at least one secondary cell unknown to the terminal device 202. For these unknown secondary cells, refined beam information are unknown to the terminal device 202 and the time period for the time and frequency synchronization would be long. Alternatively or additionally, the at least one second cell 204-2 may comprise at least one secondary cell known to the terminal device 202. For these known secondary cells, refined beam information are known to the terminal device 202 and the time period for the time and frequency synchronization would be short.

By implementing the embodiments described with reference to FIG. 2, enhanced PL-RS measurement for reducing SCell activation delay is supported. With the embodiments as described above, the default PL-RS could be determined in parallel with/during the process of time and frequency synchronization and the terminal device 202 is able to perform the PL-RS measurement before receiving the TCI activation command, thus the additional delay caused by the PL-RS measurement could be reduced, thereby reducing the SCell activation delay.

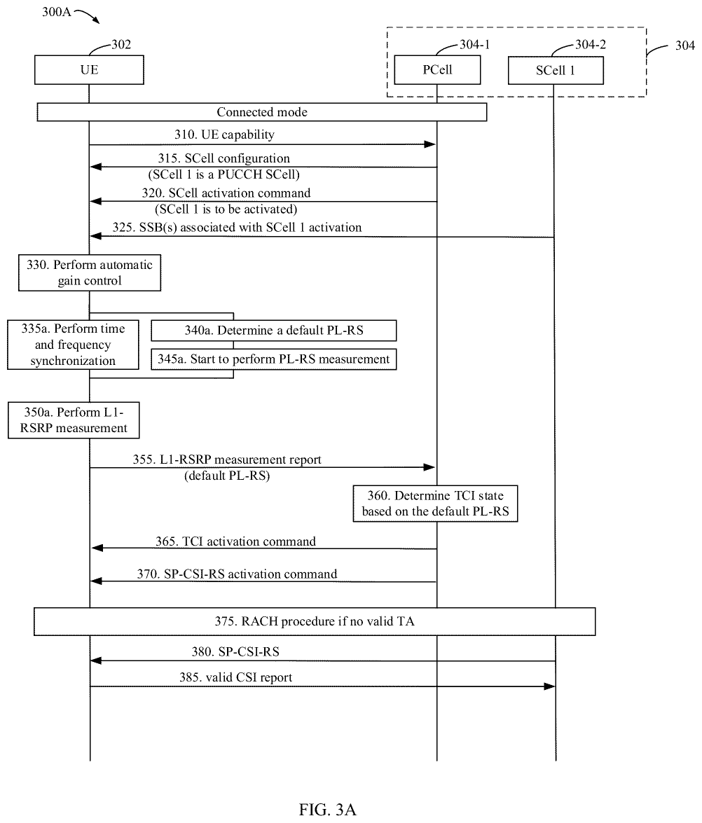

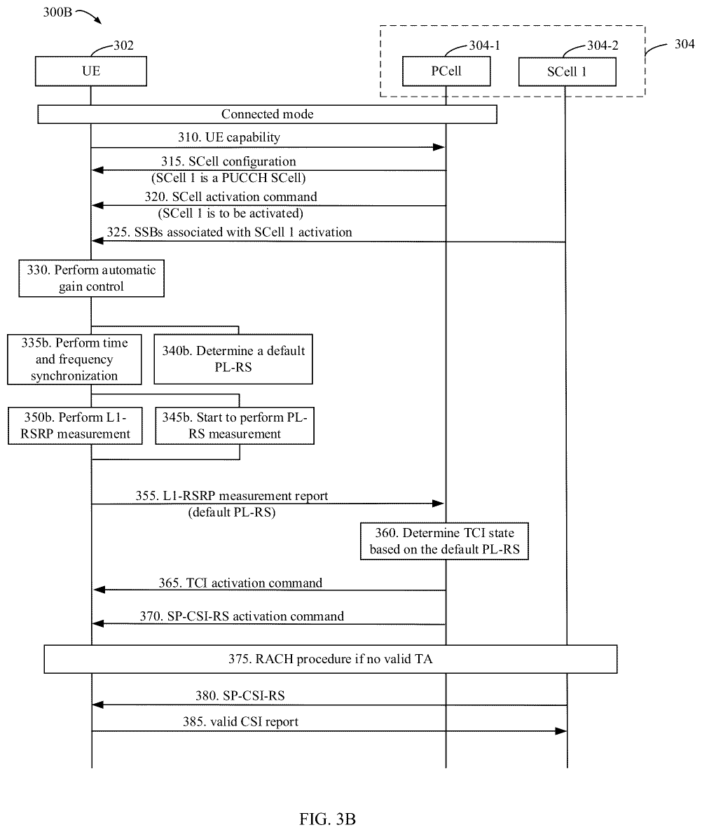

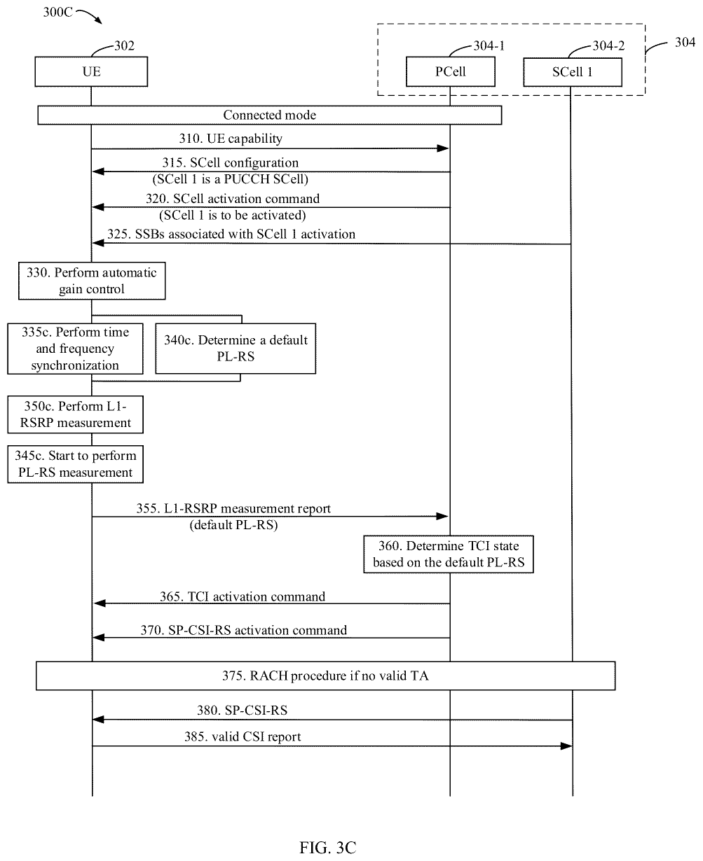

FIG. 3A illustrates an example signaling process 300A of PL-RS determination and PL-RS measurement in parallel with time and frequency synchronization in accordance with some example embodiments of the present disclosure. For ease of understanding, the process 300A will be described with reference to FIGS. 1 and 2.

As shown in FIG. 3, the process 300A may involve a UE 302, a PCell 304-1 and a SCell 1 304-2. The UE 302 is in a connected mode with the PCell 304-1. The UE 302 could be the terminal device 102 in FIG. 1 or the terminal device 202 in FIG. 2, the PCell 304-1 could be a PCell served by the network device 104-1 in FIG. 1 or the first cell 204-1 in FIG. 2, and the SCell 1 304-2 could be a SCell served by the network device 104-2 in FIG. 1 or the second cell 204-2 in FIG. 2. Alternatively, the SCell 1 304-2 could be a SCell also served by the network device 104-1 in FIG. 1. The PCell 304-1 and the SCell 1 304-2 could be called as a network device 304 collectively.

At 310, the UE 302 transmits, to the PCell 304-1, UE capability information indicating the UE 302 is capable of using or prioritizing a default PL-RS for the activation of the SCell 1 304-2.

At 315, the UE 302 receives, from the network device 304 via the PCell 304-1, SCell configuration information indicating the SCell 1 304-2 is a PUCCH SCell. Then the SCell 1 304-2 is configured for SCell activation or addition.

At 320, the UE 302 receives, from the network device 304 via the PCell 304-1, an activation command for activating the SCell 1 304-2. In this scenario, the SCell 1 304-2 is an unknown PUCCH SCell and is to be activated.

At 325, the UE 302 receives, from the network device 304 via the SCell 1 304-2, at least one SSB associated with the activation of the SCell 1 304-2.

At 330, the UE 302 performs automatic gain control. In some other example embodiments, the SCell 1 304-2 may be a known PUCCH SCell, and then the UE 302 does not need to perform the automatic gain control under such embodiments.

At 335a, the UE 302 performs time and frequency synchronization based on the at least one SSB. During (in parallel with) the time and frequency synchronization of 335a, at 340a, the UE 302 determines the default PL-RS based on the at least one SSB. In some example embodiments, the UE 302 may select one or more SSB from the at least one SSB as the default PL-RS.

After 340a, still during (in parallel with) the time and frequency synchronization of 335a, at 345a, the UE 302 starts to perform PL-RS measurement on the default PL-RS. At 350a, the UE 302 performs an L1-RSRP measurement based on the at least one SSB after the time and frequency synchronization. In some example embodiments, the PL-RS measurement on the default PL-RS may be completed during the time period for the time and frequency synchronization if the time period for the time and frequency synchronization is long enough. In some other example embodiments, the PL-RS measurement on the default PL-RS may be parallel with part of the time and frequency synchronization and at least part of the L1-RSRP measurement if the time period for the time and frequency synchronization is not long enough. In other words, the PL-RS measurement delay can be completely or partially covered by the time and synchronization delay and the L1-RSRP measurement delay.

In some example embodiments, the delay impact due to the PL-RS measurement on an overall SCell activation delay could be expressed as max (n×Tᵣₛ, T_{T/F}+T_{L1-RSRP}), wherein n is a number of SSBs required for the PL-RS measurement (e.g., n=3), Tᵣₛ represents a periodicity of a reference signal used as the PL-RS, T_{T/F} represents a periodicity of time and frequency synchronization and also could be represented by T_{SSB}, and T_{L1-RSRP} represents a periodicity of L1-RSRP measurement.

In some example embodiments, the UE 302 may indicate the network device 304 that the UE 302 has a capability of using a small beam sweeping factor for faster time and frequency synchronization. Assuming that the small beam sweeping factor is represented by X1, then T_{T/F} would be X1×T_{SSB}.

At 355, the UE 302 transmits, to the network device via the PCell 304-1, an L1-RSRP measurement report indicating the default PL-RS. In some example embodiments, the UE 302 may transmit, to the network device 304, an L1-RSRP measurement report only containing an L1-RSRP measurement result corresponding to the default PL-RS. Alternatively or additionally, the UE 302 may transmit, to the network device, an L1-RSRP measurement report containing a PL-RS measurement result on the default PL-RS. Alternatively or additionally, the UE 302 may transmit, to the network device, an L1-RSRP measurement report containing the default PL-RS.

At 360, the PCell 304-1 determines a TCI state based on the default PL-RS indicated.

At 365, the network device 304 transmits, to the UE 302 via the PCell 304-1, a TCI activation command containing the TCI state determined based on the default PL-RS.

At 370, the network device 304 transmits, to the UE 302 via the PCell 304-1, a semi-persistent channel state information reference signal (SP-CSI-RS) activation command.

At 375, the UE 302 performs a random access channel (RACH) procedure with the network device 304 via the SCell 1 304-2 if the UE 302 does not have a valid timing advance (TA) value for performing transmission on the SCell 1 304-2.

At 380, the network device 304 transmits, to the UE 302 via the SCell 1 304-2, at least one SP-CSI-RS.

At 385, the UE 302 transmits, to the network device 304 via the SCell 1 304-2, a valid CSI report, which could be an ending point of the activation of the SCell 1 304-2.

By implementing the embodiments described with reference to FIG. 3A, the default PL-RS could be determined in parallel with/during the process of time and frequency synchronization and the UE 302 is able to start to perform the PL-RS measurement in parallel with/during the process of the time and frequency synchronization.

FIG. 3B illustrates an example signaling process 300B of PL-RS determination in parallel with time and frequency synchronization and PL-RS measurement after time and frequency synchronization in accordance with some example embodiments of the present disclosure. FIG. 3B mainly differs from FIG. 3A in 345b while other processes are basically same as FIG. 3A. For brevity, most of the contents of FIG. 3B same as those of FIG. 3A will be omitted and the following will mainly describe the differences between FIG. 3A and FIG. 3B.

At 335b, the UE 302 performs time and frequency synchronization based on the at least one SSB. During (in parallel with) the time and frequency synchronization of 335b, at 340b, the UE 302 determines the default PL-RS based on the at least one SSB. In some example embodiments, the UE 302 may select one or more SSB from the at least one SSB as the default PL-RS.

At 345b, the UE 302 starts to perform PL-RS measurement on the default PL-RS immediately after the time and frequency synchronization of 335b. At 350b, the UE 302 performs an L1-RSRP measurement based on the at least one SSB after the time and frequency synchronization. As can be seen, 345b is in parallel with 350b. In some example embodiments, the PL-RS measurement on the default PL-RS may be completed during the time period for the L1-RSRP measurement if the time period for the L1-RSRP measurement is long enough. In some other example embodiments, the PL-RS measurement on the default PL-RS may be parallel with part of the L1-RSRP measurement if the time period for the L1-RSRP measurement is not long enough.

By implementing the embodiments described with reference to FIG. 3B, the default PL-RS could be determined in parallel with/during the process of time and frequency synchronization and the UE 302 is able to start to perform the PL-RS measurement immediately after the process of the time and frequency synchronization.

FIG. 3C illustrates an example signaling process 300C of PL-RS determination in parallel with time and frequency synchronization and PL-RS measurement after time and frequency synchronization in accordance with some other example embodiments of the present disclosure. FIG. 3C mainly differs from FIGS. 3A and 3B in 345c while other processes are basically same as FIGS. 3A and 3B. For brevity, most of the contents of FIG. 3C same as those of FIG. 3A will be omitted and the following will mainly describe the differences between FIG. 3A and FIG. 3C.

At 335c, the UE 302 performs time and frequency synchronization based on the at least one SSB. During (in parallel with) the time and frequency synchronization of 335c, at 340c, the UE 302 determines the default PL-RS based on the at least one SSB. In some example embodiments, the UE 302 may select one or more SSB from the at least one SSB as the default PL-RS.

At 350c, the UE 302 performs an L1-RSRP measurement based on the at least one SSB after the time and frequency synchronization. Then, at 345c, the UE 302 starts to perform PL-RS measurement on the default PL-RS after the L1-RSRP measurement of 350c.

By implementing the embodiments described with reference to FIG. 3C, the default PL-RS could be determined in parallel with/during the process of time and frequency synchronization and the UE 302 is able to start to perform the PL-RS measurement immediately after the process of the L1-RSRP measurement and before receiving the TCI activation command.

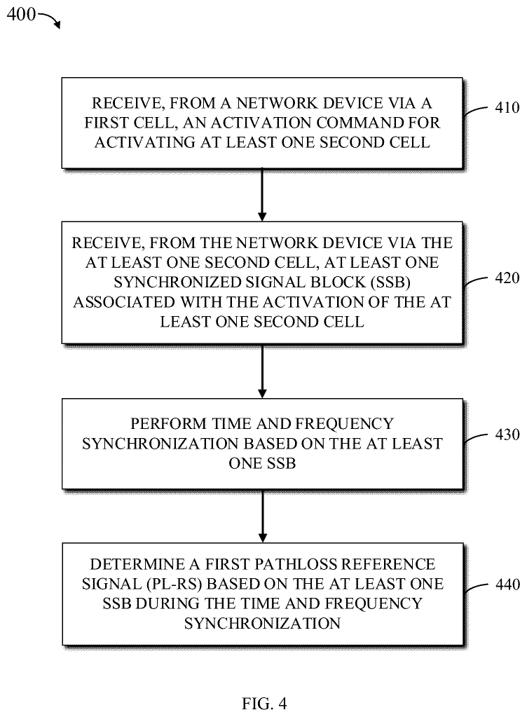

FIG. 4 illustrates a flowchart of an example method 400 implemented at a terminal device (for example, a terminal device 202 or a UE 302) in accordance with some embodiments of the present disclosure. For ease of understanding, the method 400 will be described from the perspective of the terminal device 202 with reference to FIG. 2.

At block 410, the terminal device 202 receives, from a network device 204 via a first cell 204-1, an activation command for activating at least one second cell 204-2. At block 420, the terminal device 202 receives, from the network device 204 via the at least one second cell 204-2, at least one synchronized signal block (SSB) associated with the activation of the at least one second cell 204-2. At block 430, the terminal device 202 performs time and frequency synchronization based on the at least one SSB. At block 440, the terminal device 202 determines a first pathloss reference signal (PL-RS) based on the at least one SSB during the time and frequency synchronization.

In some example embodiments, the terminal device 202 is further caused to: start to perform PL-RS measurement on the first PL-RS during the time and frequency synchronization; or start to perform PL-RS measurement on the first PL-RS after the time and frequency synchronization.

In some example embodiments, the terminal device 202 is caused to start to perform the PL-RS measurement on the first PL-RS after the time and frequency synchronization by: starting to perform the PL-RS measurement on the first PL-RS immediately after the time and frequency synchronization.

In some example embodiments, the terminal device 202 is further caused to: perform a layer 1 reference signal receiving power (L1-RSRP) measurement based on the at least one SSB after the time and frequency synchronization.

In some example embodiments, the terminal device 202 is caused to start to perform the PL-RS measurement on the first PL-RS after the time and frequency synchronization by: starting to perform the PL-RS measurement on the first PL-RS after the L1-RSRP measurement.

In some example embodiments, the terminal device 202 is further caused to: transmit, to the network device 204 via the first cell 204-1, a first indication of the first PL-RS.

In some example embodiments, the terminal device 202 is caused to transmit the first indication of the first PL-RS to the network device 204 by at least one of the following: transmitting, to the network device 204, an L1-RSRP measurement report only containing an L1-RSRP measurement result corresponding to the first PL-RS; transmitting, to the network device 204, an L1-RSRP measurement report containing a PL-RS measurement result on the first PL-RS; transmitting, to the network device 204, an L1-RSRP measurement report containing the first PL-RS; transmitting, to the network device 204, a layer 3 reference signal receiving power (L3-RSRP) measurement report containing the first PL-RS; or transmitting, to the network device 204, a channel state information (CSI) report containing the first PL-RS.

In some example embodiments, the terminal device 202 is further caused to: receive, from the network device 204, a transmission configuration indicator (TCI) activation command containing a TCI state determined based on the first PL-RS.

In some example embodiments, the TCI activation command further comprises a second PL-RS, and the terminal device 202 is further caused to: determine whether to use the first PL-RS or the second PL-RS for determining a physical uplink control channel (PUCCH) transmission power for transmitting a CSI report for the at least one second cell 204-2.

In some example embodiments, the terminal device 202 is further caused to: based on determining to use the first PL-RS for determining the PUCCH transmission power, keep using the PL-RS measurement on the first PL-RS; or based on determining to use the second PL-RS for determining the PUCCH transmission power, perform PL-RS measurement on the second PL-RS.

In some example embodiments, the terminal device 202 is further caused to: transmit, to the network device 204, a second indication indicating whether or not the terminal device 202 uses the first PL-RS for determining the PUCCH transmission power.

In some example embodiments, before receiving the activation command, the terminal device 202 is further caused to: transmit, to the network device 204, a third indication indicating the terminal device 202 is capable of using or prioritizing the first PL-RS for the activation of the at least one second cell 204-2.

In some example embodiments, before receiving the activation command, the terminal device 202 is further caused to: transmit, to the network device 204, a fourth indication indicating the terminal device 202 is capable of using a small beam sweeping factor for faster time and frequency synchronization.

In some example embodiments, the at least one second cell 204-2 comprises at least one of the following: at least one secondary cell unknown to the terminal device 202; or at least one secondary cell known to the terminal device 202.

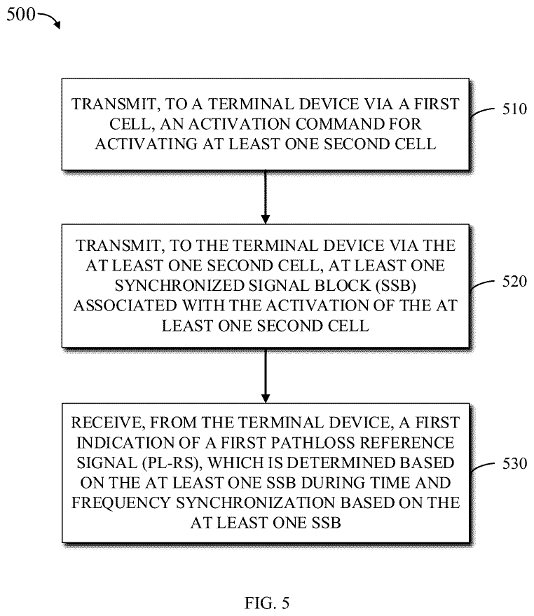

FIG. 5 illustrates a flowchart of an example method 500 implemented at a network device (for example, a network device 204 or a network device 304) in accordance with some embodiments of the present disclosure. For ease of understanding, the method 500 will be described from the perspective of the network device 204 with reference to FIG. 2.

At block 510, the network device 204 transmits, to a terminal device 202 via a first cell 204-1, an activation command for activating at least one second cell 204-2. At block 520, the network device 204 transmits, to the terminal device 202 via the at least one second cell 204-2, at least one synchronized signal block (SSB) associated with the activation of the at least one second cell 204-2. At block 530, the network device 204 receives, from the terminal device 202, a first indication of a first pathloss reference signal (PL-RS), which is determined based on the at least one SSB during time and frequency synchronization based on the at least one SSB.

In some example embodiments, the network device 204 is caused to receive the first indication of the first PL-RS from the terminal device 202 by at least one of the following: receiving, from the terminal device 202, a layer 1 reference signal receiving power (L1-RSRP) measurement report only containing an L1-RSRP measurement result corresponding to the first PL-RS; receiving, from the terminal device 202, an L1-RSRP measurement report containing a PL-RS measurement result on the first PL-RS; receiving, from the terminal device 202, an L1-RSRP measurement report containing the first PL-RS; receiving, from the terminal device 202, a layer 3 reference signal receiving power (L3-RSRP) measurement report containing the first PL-RS; or receiving, from the terminal device 202, a channel state information (CSI) report containing the first PL-RS.

In some example embodiments, the network device 204 is further caused to: determine a transmission configuration indicator (TCI) state based on the first PL-RS.

In some example embodiments, the network device 204 is further caused to: transmit, to the terminal device 202, a TCI activation command containing the TCI state determined based on the first PL-RS.

In some example embodiments, the TCI activation command further comprises a second PL-RS.

In some example embodiments, the network device 204 is further caused to: receive, from the terminal device 202, a second indication indicating whether or not the terminal device 202 uses the first PL-RS for determining a physical uplink control channel (PUCCH) transmission power for transmitting a CSI report for the at least one second cell 204-2.

In some example embodiments, the network device 204 is further caused to: receive, from the terminal device 202, a third indication indicating the terminal device 202 is capable of using or prioritizing the first PL-RS for the activation of the at least one second cell 204-2.

In some example embodiments, the network device 204 is further caused to: receive, from the terminal device 202, a fourth indication indicating the terminal device 202 is capable of using a small beam sweeping factor for faster time and frequency synchronization.

In some example embodiments, the at least one second cell 204-2 comprises at least one of the following: at least one secondary cell unknown to the terminal device 202; or at least one secondary cell known to the terminal device 202.

In some example embodiments, an apparatus capable of performing the method 400 (for example, the terminal device 202) may comprise means for performing the respective steps of the method 400. The means may be implemented in any suitable form. For example, the means may be implemented in a circuitry or software module.

In some example embodiments, the apparatus comprises: means for receiving, from a network device 204 via a first cell 204-1, an activation command for activating at least one second cell 204-2; means for receiving, from the network device 204 via the at least one second cell 204-2, at least one synchronized signal block (SSB) associated with the activation of the at least one second cell 204-2; means for performing time and frequency synchronization based on the at least one SSB; and means for determining a first pathloss reference signal (PL-RS) based on the at least one SSB during the time and frequency synchronization.

In some embodiments, the apparatus further comprises means for performing other processes in some embodiments of the method 400. In some embodiments, the means comprises at least one processor and at least one memory including computer program code, the at least one memory and computer program code configured to, with the at least one processor, cause the performance of the apparatus.

In some example embodiments, an apparatus capable of performing the method 500 (for example, the network device 204) may comprise means for performing the respective steps of the method 500. The means may be implemented in any suitable form. For example, the means may be implemented in a circuitry or software module.

In some example embodiments, the apparatus comprises: means for transmitting, to a terminal device 202 via a first cell 204-1, an activation command for activating at least one second cell 204-2; means for transmitting, to the terminal device 202 via the at least one second cell 204-2, at least one synchronized signal block (SSB) associated with the activation of the at least one second cell 204-2; and means for receiving, from the terminal device 202, a first indication of a first pathloss reference signal (PL-RS), which is determined based on the at least one SSB during time and frequency synchronization based on the at least one SSB.

In some embodiments, the apparatus further comprises means for performing other processes in some embodiments of the method 500. In some embodiments, the means comprises at least one processor and at least one memory including computer program code, the at least one memory and computer program code configured to, with the at least one processor, cause the performance of the apparatus.

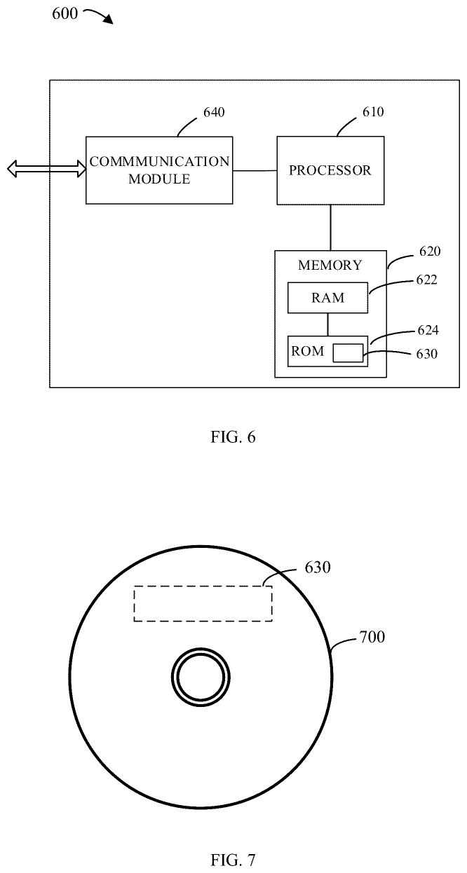

FIG. 6 illustrates an example simplified block diagram of a device 600 that is suitable for implementing embodiments of the present disclosure. The device 600 may be provided to implement a communication device or a network element, for example, the terminal device 202 or the network device 204 as shown in FIG. 2. As shown, the device 600 includes one or more processors 610, one or more memories 620 may couple to the processor 610, and one or more communication modules 640 may couple to the processor 610.

The communication module 640 is for bidirectional communications. The communication module 640 has at least one antenna to facilitate communication. The communication interface may represent any interface that is necessary for communication with other network elements, for example the communication interface may be wireless or wireline to other network elements, or software based interface for communication.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a read only memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program so that the device 600 may perform any process of the disclosure as discussed with reference to FIG. 2. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400 or 500 as described above with reference to FIG. 4 or FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one processor; and
at least one memory storing instructions that, when executed by the at least one processor, cause the terminal device at least to:
receive, from a network device via a first cell, an activation command for activating at least one second cell;
receive, from the network device via the at least one second cell, at least one synchronized signal block (SSB) associated with the activation of the at least one second cell;
perform time and frequency synchronization based on the at least one SSB; and
determine a first pathloss reference signal (PL-RS) based on the at least one SSB during the time and frequency synchronization.

2. The terminal device of claim 1, wherein the terminal device is further caused to:
start to perform PL-RS measurement on the first PL-RS during the time and frequency synchronization; or
start to perform PL-RS measurement on the first PL-RS after the time and frequency synchronization.

3. The terminal device of claim 2, wherein the terminal device is caused to start to perform the PL-RS measurement on the first PL-RS after the time and frequency synchronization by:
starting to perform the PL-RS measurement on the first PL-RS immediately after the time and frequency synchronization.

4. The terminal device of claim 2, wherein the terminal device is further caused to:
perform a layer 1 reference signal receiving power (L1-RSRP) measurement based on the at least one SSB after the time and frequency synchronization.

5. The terminal device of claim 4, wherein the terminal device is caused to start to perform the PL-RS measurement on the first PL-RS after the time and frequency synchronization by:
starting to perform the PL-RS measurement on the first PL-RS after the L1-RSRP measurement.

6. The terminal device of claims 1, wherein the terminal device is further caused to:
transmit, to the network device via the first cell, a first indication of the first PL-RS.

7. The terminal device of claim 6, wherein the terminal device is caused to transmit the first indication of the first PL-RS to the network device by at least one of the following:
transmitting, to the network device, an L1-RSRP measurement report only containing an L1-RSRP measurement result corresponding to the first PL-RS;
transmitting, to the network device, an L1-RSRP measurement report containing a PL-RS measurement result on the first PL-RS;
transmitting, to the network device, an L1-RSRP measurement report containing the first PL-RS;
transmitting, to the network device, a layer 3 reference signal receiving power (L3-RSRP) measurement report containing the first PL-RS; or
transmitting, to the network device, a channel state information (CSI) report containing the first PL-RS.

8. The terminal device of claim 1, wherein the terminal device is further caused to:
receive, from the network device, a transmission configuration indicator (TCI) activation command containing a TCI state determined based on the first PL-RS.

9. The terminal device of claim 8, wherein the TCI activation command further comprises a second PL-RS, and the terminal device is further caused to:
determine whether to use the first PL-RS or the second PL-RS for determining a physical uplink control channel (PUCCH) transmission power for transmitting a CSI report for the at least one second cell.

10. The terminal device of claim 9, wherein the terminal device is further caused to:
based on determining to use the first PL-RS for determining the PUCCH transmission power, keep using the PL-RS measurement on the first PL-RS; or
based on determining to use the second PL-RS for determining the PUCCH transmission power, perform PL-RS measurement on the second PL-RS.

11. The terminal device of claim 9, wherein the terminal device is further caused to:
transmit, to the network device, a second indication indicating whether or not the terminal device uses the first PL-RS for determining the PUCCH transmission power.

12. The terminal device of claim 1, wherein before receiving the activation command, the terminal device is further caused to:
transmit, to the network device, a third indication indicating the terminal device is capable of using or prioritizing the first PL-RS for the activation of the at least one second cell.

13. The terminal device of claim 1, wherein before receiving the activation command, the terminal device is further caused to:
transmit, to the network device, a fourth indication indicating the terminal device is capable of using a small beam sweeping factor for faster time and frequency synchronization.

14. The terminal device of claim 1, wherein the at least one second cell comprises at least one of the following:
at least one secondary cell unknown to the terminal device; or
at least one secondary cell known to the terminal device.

15. A network device comprising:
at least one processor; and
at least one memory storing instructions that, when executed by the at least one processor, cause the network device at least to:
transmit, to a terminal device via a first cell, an activation command for activating at least one second cell;
transmit, to the terminal device via the at least one second cell, at least one synchronized signal block (SSB) associated with the activation of the at least one second cell; and
receive, from the terminal device, a first indication of a first pathloss reference signal (PL-RS), which is determined based on the at least one SSB during time and frequency synchronization based on the at least one SSB.

16. The network device of claim 15, wherein the network device is caused to receive the first indication of the first PL-RS from the terminal device by at least one of the following:
receiving, from the terminal device, a layer 1 reference signal receiving power (L1-RSRP) measurement report only containing an L1-RSRP measurement result corresponding to the first PL-RS;
receiving, from the terminal device, an L1-RSRP measurement report containing a PL-RS measurement result on the first PL-RS;
receiving, from the terminal device, an L1-RSRP measurement report containing the first PL-RS;
receiving, from the terminal device, a layer 3 reference signal receiving power (L3-RSRP) measurement report containing the first PL-RS; or
receiving, from the terminal device, a channel state information (CSI) report containing the first PL-RS.

17. The network device of claim 15, wherein the network device is further caused to:
determine a transmission configuration indicator (TCI) state based on the first PL-RS.

18. The network device of claim 17, wherein the network device is further caused to:
transmit, to the terminal device, a TCI activation command containing the TCI state determined based on the first PL-RS.

19. The network device of claim 18, wherein the TCI activation command further comprises a second PL-RS.

20. A method comprising:
receiving, from a network device via a first cell, an activation command for activating at least one second cell;
receiving, from the network device via the at least one second cell, at least one synchronized signal block (SSB) associated with the activation of the at least one second cell;
performing time and frequency synchronization based on the at least one SSB; and
determining a first pathloss reference signal (PL-RS) based on the at least one SSB during the time and frequency synchronization.
